(19) United States
(12) Patent Application Publication
(10) Pub. No.: US 2005/0198072 A1
(43) Pub. Date: Sep. 8, 2005

(54) Scan file generation system

(75) Inventors: Satoshi Iinuma, Nagano (JP); Yuji Matsueda, Nagano (JP); Yukinobu Momozono, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/060,584

(22) Filed: Feb. 18, 2005

(30) Foreign Application Priority Data
Feb. 18, 2004 (JP) P2004-041347

(51) Int. Cl. G06F 7/00

(52) U.S. Cl. 707/104.1

(57) ABSTRACT

The present invention provides a scan file generation system that permits a user to easily use a scan file generated by the system. The scan file generation system comprises a scan data generation apparatus and a scan file generation apparatus, which is operated upon the reception of a user name and image data from the scan data generation apparatus, and which includes: a function for generating a scan file, which is a file comprising the image data received from the scan data generation apparatus, and for internally storing the scan file, in correlation with the user name received from the scan data generation apparatus, so that the scan file can be employed by using a Web browser; and a function for supplying, when a user logs in using his or her user name, a user homepage whereon a link is provided to a scan file, which is internally stored in correlation with the user name.

### BACKGROUND OF THE INVENTION

The present invention relates to a scan file generation system for employing image data obtained by scanning a document, and for generating a scan file as an image data file for the document.

Of the currently available digital multifunction apparatuses, some can perform scan-to-file and scan-to-email processes while connected, by a LAN, to a computer in which a predetermined program (hereinafter referred to as a scan agent program) has previously been installed (see CS-7000 User's Manual by Seiko Epson Corp.).

A scan-to-file process is a process whereby, as is specifically shown in FIG. 19A, a digital multifunction apparatus transmits scan data (document image data secured by the scanner of a digital multifunction apparatus) to a scan agent computer, a computer wherein a scan agent program has been installed, and wherein the scan agent computer stores a scan file, a data file comprising data obtained by processing scan data (data obtained by changing a data form), at a location designated by a user (a common folder in one of several computers). The scan-to-email process is a process whereby, as is shown in FIG. 19B, a digital multifunction apparatus transmits scan data to a scan agent computer, and whereby the scan agent computer then generates a scan file and transmits, to an address designated by a user, a scan email, which is an email to which the generated scan file has been attached.

A system comprising a digital multifunction apparatus and a scan agent computer is a system that does not particularly include a configuration for extracting a scan file from a folder wherein the file is stored, i.e., a system that employs an OS function to extract a scan file from a storage destination folder. Therefore, for a user who is not familiar with computer operations, this is a difficult system with which to perform an operation for actually employing a scan file.

It is, therefore, one objective of the present invention to provide a scan file generation system that can, based on image data obtained by scanning a document, generate as a scan file an image data file that is related to the document, and that permits a user to easily utilize the thus generated scan file.

### SUMMARY OF THE INVENTION

To achieve this objective, according to the present invention, a scan file generation system, which is connected to a computer network constituted by several computers wherein Web browsers are installed, comprises: one scan data generation apparatus, at the least; and one scan file generation apparatus, wherein the scan data generation apparatus includes a document scanner for scanning a document that has been mounted and generating image data representing an image of the document, a user interface unit for permitting a user to perform various operations, including an input operation for a name allocated to the user, and a controller for, when predetermined operations, including the input operation for the user name, are performed, using the interface unit to transmit user name information, indicating the user name entered during the input operation, to the scan file generation apparatus, and for also starting a document scanner operation and transmitting image data, produced by the document scanner, to the scan file generation apparatus, and wherein the scan file generation apparatus includes a scan file generation/storage unit for receiving the user name information and the image data from the controller of the scan data generation apparatus, for generating a scan file that is related to the image data, and for storing the scan file in correlation with the user name indicated by the user name information, and a scan file provision unit having a function for displaying a scan file selection page, which is a Web page, on which a computer that has performed the predetermined procedures for a Web browser, including an input operation for a user name, is permitted to arbitrarily select a scan file that is stored in the scan file generation/storage unit in correlation with the user name, and having a function for providing, for a computer that has selected a scan file on the currently displayed scan file selection page, the scan file that has been thus selected and is stored in the scan file generation/storage unit.

According to the thus arranged scan file generation system of the present invention, to employ the individual scan files generated by the system, a user need only display a scan file selection page on a Web browser. Therefore, a user can utilize scan files more easily with this scan file generation system than with a conventional system (FIG. 19).

Furthermore, for the scan file generation system of the present invention, the scan data generation apparatus can further include a user interface unit for enabling a designation operation for designating a folder, and a controller for transmitting, to the scan file generation apparatus, folder information indicating the folder designated by the designation operation performed using the user interface unit. And the scan file generation apparatus can further include a first scan file generation/storage unit, to be operated only upon receiving, from the controller, folder information representing predetermined contents, and a second scan file generation/storage unit, to be operated upon receiving, from the controller, folder information representing contents differing from the predetermined contents, for receiving user name information and image data from the controller of the scan data generation apparatus, for generating a scan file that is related to the image data, and for storing the scan file in a folder designated in the folder information. According to the present invention, a location in which to store a scan file can be designated for the thus arranged scan file generation system.

In addition, for the scan file generation system of the invention, the scan file generation apparatus may further include: a third scan file generation/storage unit for storing scan files having forms identifiable by using URLs; an email address storage unit for storing email addresses in consonance with a plurality of user names; and a process end notification email transmission unit for, when a new scan file is stored in the third scan file generation/storage unit, setting a URL for the new scan file in text and transmitting a process end notification email to an email address that is stored, as a destination address, in the email address storage unit in correlation with a user name. Or the scan file generation apparatus may further include: an effective period information storage unit for storing, for each of a plurality of user names, effective period information representing a period of time; and a scan file deletion unit for managing elapsed time following the storage of a scan file in the scan file generation/storage unit, and for deleting the scan file when the elapsed time exceeds the period of time represented by the effective period information stored, in correlation with a corresponding user name, in the effective period information storage unit.

The present disclosure relates to the subject matter contained in Japanese patent application No. 2004-041347 (filed on Feb. 18, 2004), which is expressly incorporated herein by reference in its entirety.

### BRIEF DESCRIPTION OF THE DRAWINGS

FIG. 1 is a diagram for explaining the configuration of and the use condition for a scan file generation system according to one embodiment of the present invention.

FIG. 2 is a diagram showing the external appearance of a digital multifunction apparatus included in the scan file generation system according to the embodiment.

FIG. 3 is a diagram showing the configuration of the digital multifunction apparatus.

FIG. 4 is a diagram showing the external appearance of the control unit of the digital multifunction apparatus.

FIG. 5 is a diagram for explaining a scan user setup page that a scan agent computer displays on a Web browser.

FIG. 6 is a diagram for explaining a destination setup page that the scan agent computer displays on the Web browser.

FIG. 7 is a diagram for explaining a destination group setup page that the scan agent computer displays on the Web browser.

FIG. 8 is a diagram for explaining a folder setup page that the scan agent computer displays on the Web browser.

FIG. 9 is a diagram for explaining a basic copy screen displayed by the control unit.

FIG. 10 is a sequence diagram showing the operating procedures of the scan file generation system.

FIG. 11 is a diagram for explaining a user name selection screen displayed by the control unit.

FIG. 12 is a diagram for explaining a scan name selection screen displayed by the control unit.

FIG. 13 is a diagram for explaining a scan destination selection screen displayed by the control unit.

FIG. 14 is a diagram for explaining a scan destination confirmation/deletion screen displayed by the control unit.

FIG. 15 is a sequence diagram showing the operating procedures of the scan file generation system.

FIG. 16 is a diagram for explaining a process end notification email prepared and transmitted by the scan agent computer.

FIG. 17 is a diagram for explaining a log-in screen that the scan agent computer displays on the Web browser.

FIG. 18 is a diagram for explaining a user homepage that the scan agent computer displays on the Web browser.

FIG. 19 is a diagram for explaining a scan-to-email process and a scan-to-file process.

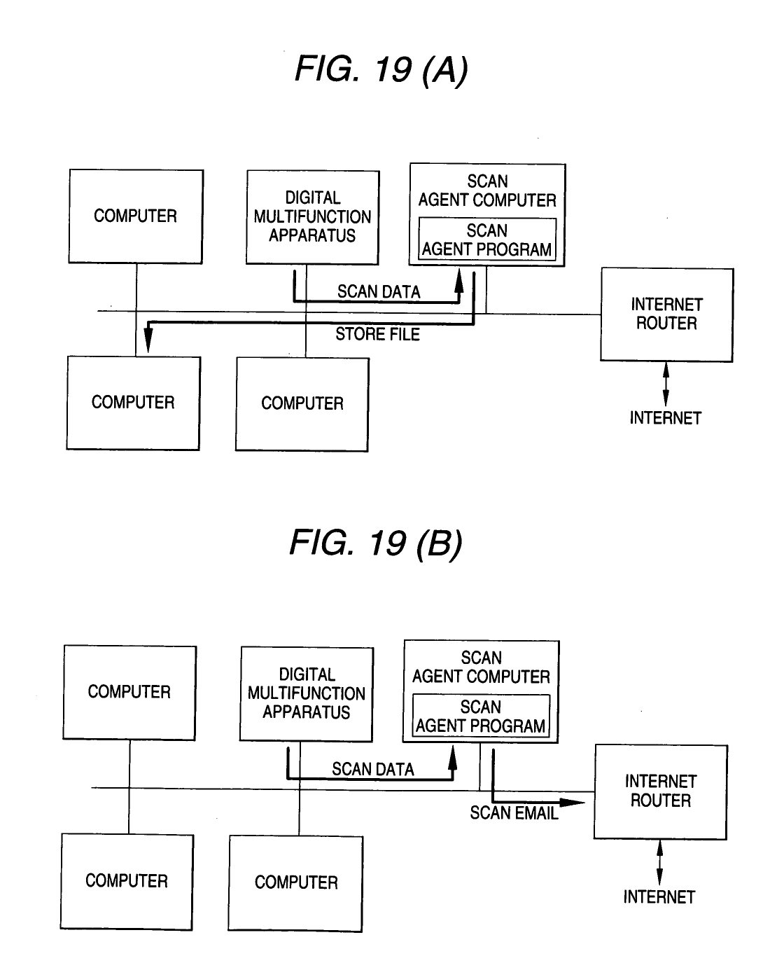

### DESCRIPTION OF THE PREFERRED EMBODIMENT

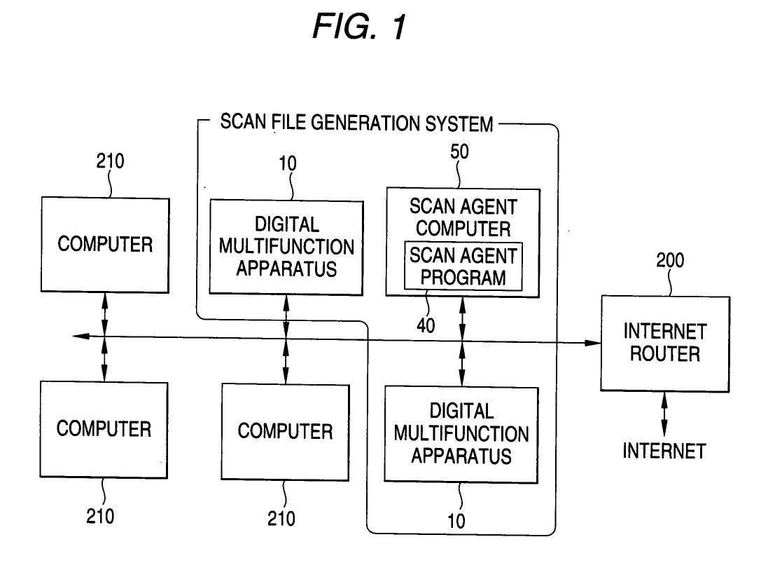

First, the hardware configuration of a scan file generation system according to one embodiment of the present invention will be described while referring to FIGS. 1 to 4.

As is shown in FIG. 1, the scan file generation system in this embodiment is a system wherein one or more (two in FIG. 1) digital multifunction apparatuses (corresponding to scan data generation apparatuses) 10 and a scan agent computer (corresponding to a scan file generation apparatus) 50 are interconnected by a network. The scan file generation system is connected to a network that includes an Internet router 200 and several computers 210.

The computers 210 are computers employed by a manager of the scan file generation system and by general users, i.e., computers wherein Web browsers are installed. The internet router 200 is an apparatus for connecting the computers 210 and the other apparatuses to the Internet.

Developed for the scan file generation system and installed in the scan agent computer 50 is a scan agent program 40. When the scan agent program 40 is installed (set up), the names of a manager, a work folder and an email server, and a password are required entries. The function of the scan agent program 40 will be described later.

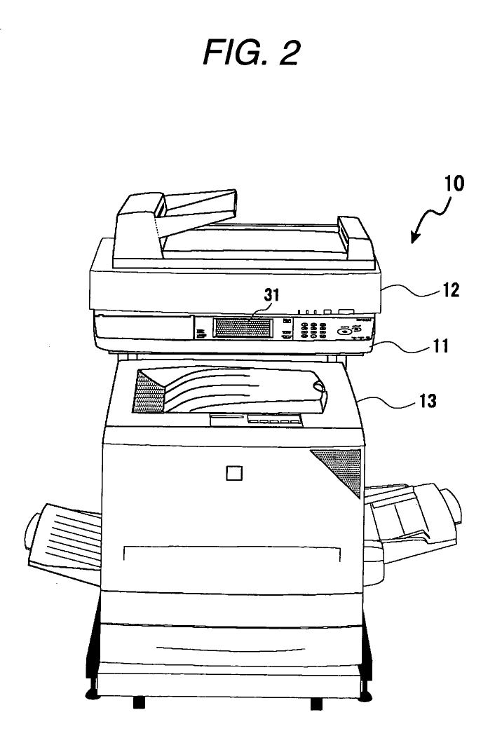

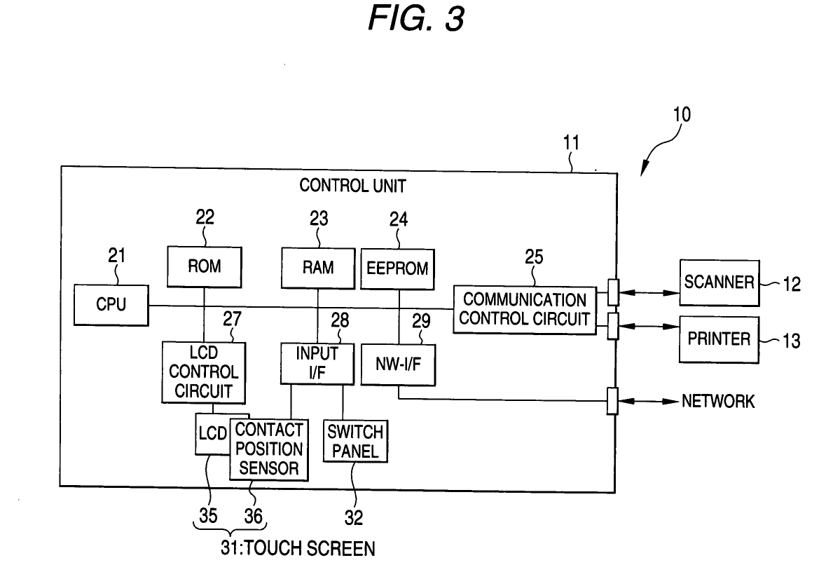

The external appearance of the digital multifunction apparatus 10 is as shown in FIG. 2, and its hardware configuration is as shown in FIG. 3. That is, the digital multifunction apparatus 10 is constituted by combining a control unit 11, a scanner 12 and a printer 13, so that it has the same external appearance as a common digital multifunction peripheral/copier (see FIG. 2).

The printer 13 used for the digital multifunction apparatus 10 is an apparatus wherein an extension board (which connects the control unit 11 and the printer 13), used to constitute the digital multifunction apparatus, is mounted in a printer that can be employed as a peripheral apparatus for a computer. The scanner 12 is an apparatus wherein an extension board (which connects the control unit 11 and the scanner 12), used to constitute the digital multifunction apparatus, is mounted in a scanner that can be employed as a peripheral apparatus for a computer.

As is shown in FIG. 3, the control unit 11 includes a CPU 21, a ROM 22, a RAM 23, an EEPROM 24, a communication control circuit 25, an LCD control circuit 27, an input interface circuit (input I/F) 28, a network interface circuit (NW-I/F) 29, a touch screen 31, and a switch 32.

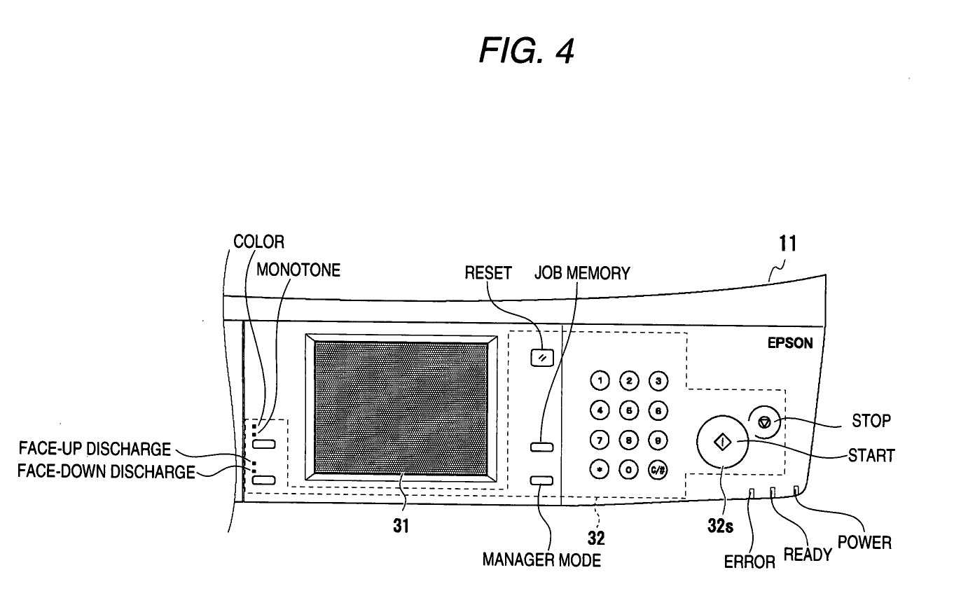

The touch screen 31 used for the control unit 11 is a device wherein a transparent, contact position sensor 36 is laminated on a liquid crystal display (LCD) device 35. As is shown in FIGS. 3 and 4, the touch screen 31 is provided on the case of the control unit 11, and the switch panel 32 (see FIGS. 3 and 4), which is also provided on the case of the control unit 11, is constituted by a start button 32s, various types of button switches, such as a ten key pad, and a control circuit for these switches.

The CPU 21 (FIG. 3) provides overall control for the several individual sections (the internal section of the control unit 11, and the scanner 12 and the printer 13) of the digital multifunction apparatus 10. The ROM 22 is a read only memory in which are stored a program for regulating the operating procedures of the CPU 21 and data used by the CPU 21 (program). The RAM 23 is a memory in which the program read from the ROM 22 is stored and in which a work area is provided for the CPU 21 (program). The communication control circuit 25 is used by the CPU 21 to exchange information (transmit commands and receive and transmit print data) with the scanner 12 or the printer 13.

The LCD control circuit 27 is a circuit for displaying, on the touch screen 31 (LCD 35), an image (screen) representing the contents of instructions issued by the CPU 21. The input interface circuit 28 is a circuit for notifying the CPU 21 of the contents of an operation a user (an operator of the digital multifunction apparatus 10) has performed using the switch panel 32 or on the touch screen 31 (contact position sensor 36). The network interface circuit 29 is a circuit for connecting the control unit 11 to a network.

The EEPROM 24 is nonvolatile rewritable memory included in the control unit 11 for the storage of various data that must be retained even when the power is off. The control unit 11 is a unit that is operated under a condition wherein the IP address of the control unit 11 (hereinafter referred to as an apparatus IP address) and the IP address of the scan agent computer 50 (hereinafter referred to as an agent IP address) are stored, i.e., a unit that requires the setting up of an apparatus IP address and an agent IP address when it is connected to the network.

With the above description as a basis, the configuration and the operation of the scan file generation system will be described in greater detail.

First, an explanation will be given for the procedures that must be performed by a manager and a user when the operation of the scan file generation system is initiated.

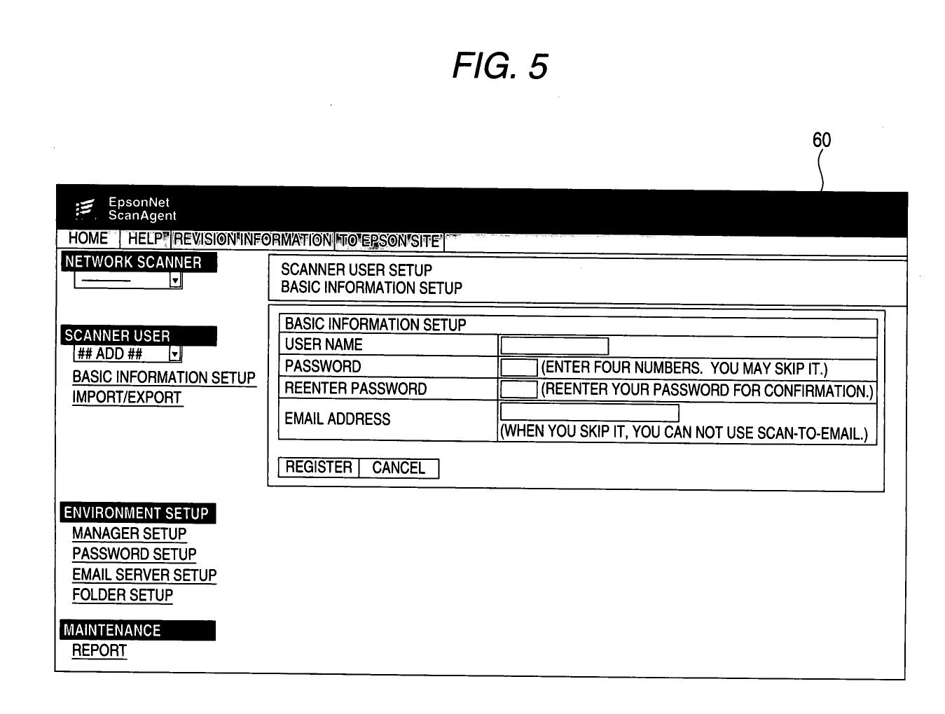

When the operation of the scan file generation system is initiated, a manager (a person having knowledge of a manager name and a password that were registered when the scan agent program 40 was installed) displays a scan user setup page 60, see FIG. 5, on his or her computer 210.

More specifically, the manager employs the Web browser to log in to the scan agent computer 50, i.e., enters a predetermined URL, including the IP address of the scan agent computer 50, for the Web browser, and inputs the manager name and the password using a login screen that is displayed as a result. Then, a manager homepage is displayed on the screen of the computer 210, and when the manager manipulates a predetermined link on the manager home page, the scan user setup page 60 is displayed.

Thereafter, the manager manipulates the scan user setup page 60, i.e., enters a user name, and clicks on a “register” button. In this manner, for each user who will employ the scan file generation system, a user name, a password and an email address (only the user name is required information) are registered.

When this processing has been completed for a specific user (hereinafter referred to as a target user), the scan agent computer 50 regards as information concerning the target user the user management information, such as the user name, that is entered using the scan user setup page 60, and stores this information internally. The scan agent computer 50 also internally prepares a folder (hereinafter referred to as a public folder, which will be described in detail later) that the target user can designate as the storage destination for a scan file (a file consisting of data obtained by processing image data that are generated by the scanner 12 of the digital multifunction apparatus 10). It should be noted that the public folder is prepared so that the individual files stored therein can be accessed by the Web browser.

Further, the scan agent computer 50 also performs a process for internally storing, as information concerning the target user, information that includes data indicating the name of a prepared public folder (“Public Folder” in this embodiment), which is displayed on the touch screen 31 of the control unit 11, and information indicating the actual location of the public folder.

When this processing has been completed for an individual user, and when the user operates an arbitrary digital multifunction apparatus 10 in the scan file generation system, the scan-to-file process can be performed.

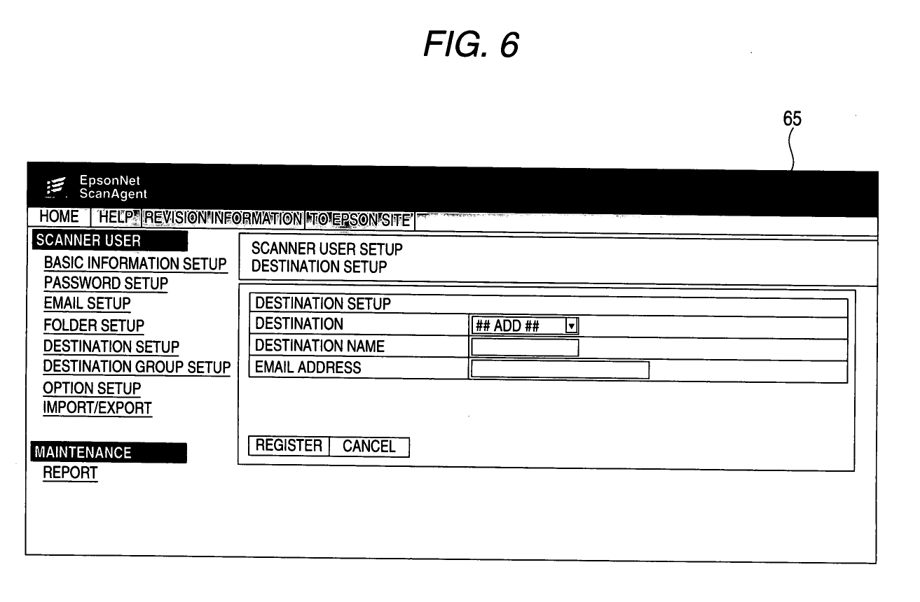

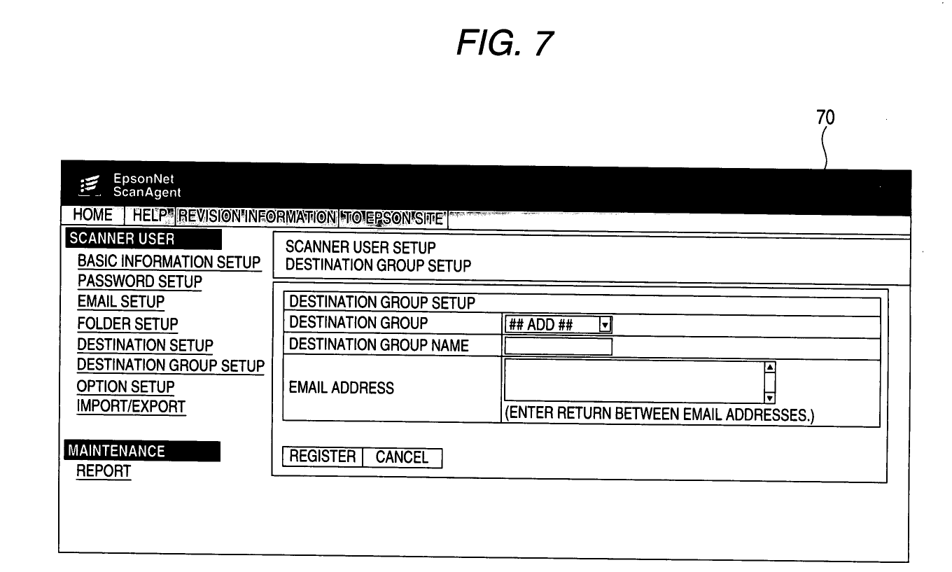

However, since the scan-to-email process can not be performed in this state, a user who desires to perform the scan-to-email process must employ the Web browser (which will be described later) to access the scan agent computer 50, and must permit his or her computer 210 to display a destination setup page 65, shown in FIG. 6. The user then employs the destination setup page 65 to store, in the scan agent computer 50, email transmission destination information for a pertinent user (hereinafter referred to as email destination information) that includes email addresses available as destinations for scan emails (emails with attached scan files) and destination names that are displayed as identification information for the email addresses on the touch screen 31 of the control unit 11. Further, for a user who may transmit to a plurality of destinations scan emails to which identical scan files are attached, his or her computer 210 displays a destination group setup page 70, shown in FIG. 7, and the user employs the destination group setup page 70 to store, in the scan agent computer 50, information concerning the user (hereinafter referred to as group destination information) that includes several email addresses and destination group names.

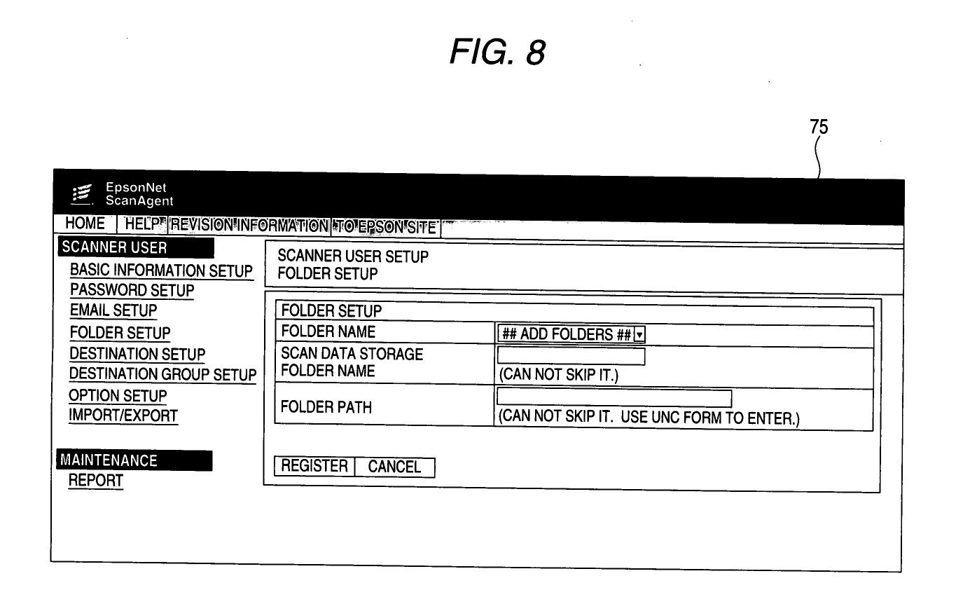

In addition, when a user also desires to save a scan file in a folder other than a public folder, i.e., a common folder in the user's computer 210, the computer 210 of the user displays a folder setup page 75, shown in FIG. 8, and folder information, such as information that includes a folder name and a folder path, is stored as information concerning the pertinent user in the scan agent computer 50. Hereinafter, this information, registered by the user, and information concerning the public folder, which is automatically registered by the scan agent computer 50 upon the registration of the user, are described as transmission destination information for saving.

Further, so long as the setup is changed for a predetermined Web page on the display, when the scan-to-file process or the scan-to-email process is terminated, the scan file generation system (the scan agent computer 50) transmits a process end notification email to the user who instructed the execution of the process (further details will be provided later). Thus, a user who desires to transmit a process end notification email need only display the Web page, and change the setup for the process end notification email.

Moreover, so long as the setup is changed using a predetermined Web page on the display, the scan file generation system (scan agent computer 50) automatically deletes from the public folder a file for which the storage period exceeds a predetermined period of time (a period designated by the user). Therefore, a user desiring to employ this function need only display the Web page and change the setup.

The operation of the scan file generation system (the control unit 11 and the scan agent computer 50) will now be described.

The control unit 11 includes an operating mode (hereinafter referred to as a copy mode) for employing the digital multifunction apparatus 10 as a copier, and an operating mode (hereinafter referred to as a scan mode) for employing as a scan file generation system the system comprising the digital multifunction apparatus 10 and the scan agent computer 50.

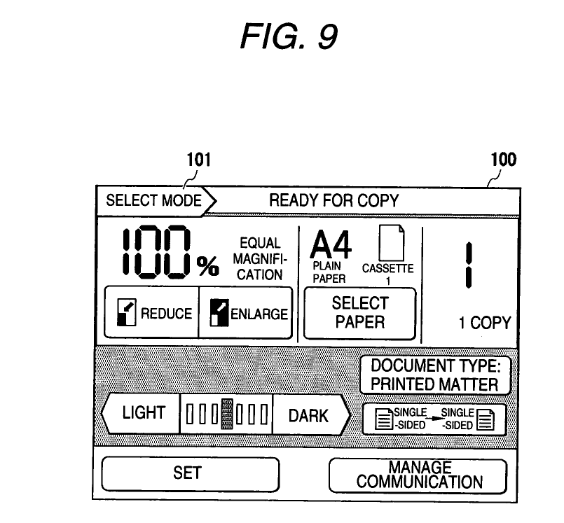

Since the control unit 11 in the copy mode displays a basic copy screen 100, shown in FIG. 9, on the touch screen 31, a user who desires to start the control unit 11 in the scan mode selects a mode select button 101 on the basic copy screen 100.

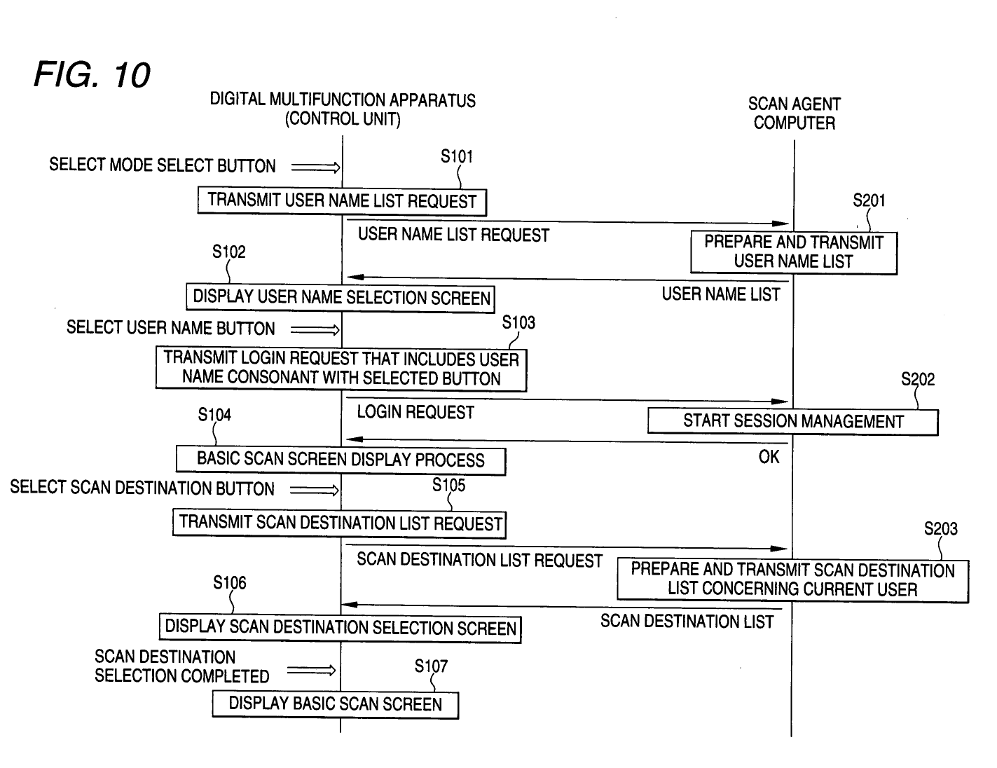

Upon the performance of this manipulation, the control unit 11 starts the operation in the scan mode, and as is shown in FIG. 10, transmits a user name list request to the scan agent computer 50 (the apparatus in which an agent IP address is stored in the EEPROM 24) (step S101 in FIG. 10).

Upon receiving the user name list request, the scan agent computer 50 employs the user management information (information registered on the scan user setup page 60, shown in FIG. 5) that is internally stored for the individual users, and prepares and transmits to the digital multifunction apparatus 10 a user name list that includes the user names of the individual users, and information indicating whether passwords have already been registered for these users (step S201).

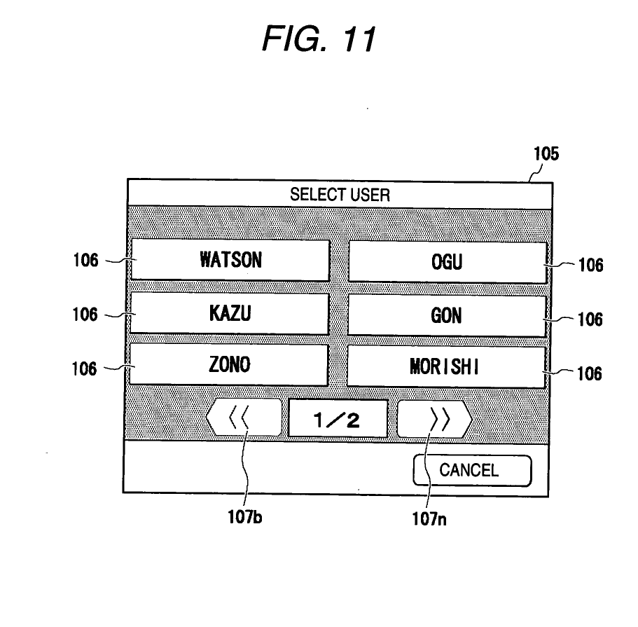

The control unit 11 employs the received user name list to display a user name selection screen 105, shown in FIG. 11, on the touch screen 31 (step S102). That is, on the touch screen 31, the control unit 11 displays the user name selection screen 105 on which are shown user name buttons 10G to which user names, included in the received user name list, are affixed.

When one of the user name buttons 106 on the user name selection screen 105 is touched, and thus selected, the control unit 11 transmits, to the scan agent computer 50, a login request that includes the user name that corresponds to the selected user name button 106 (step S103). When the selected user name button 106 is for a user whose password has been registered, the control unit 11 displays a password input screen on the touch screen 31 to request the entry, by the user, of a password. Then, the control unit 11 transmits, to the scan agent computer 50, a login request that includes the user name and the password input by the user.

The scan agent computer 50 confirms that user management information that includes the same information (the user name, or the user name and the password) as that included in the received login request has previously been stored in the computer 50. Then, the scan agent computer 50 initiates a process (session management, shown in FIG. 10) whereby, thereafter, each request received from the control unit 11 is regarded as a request from a user (hereinafter referred to as a current user) identified by the user name included in the login request (step S202). Furthermore, the scan agent computer 50 transmits information to the digital multifunction apparatus 10 (OK in FIG. 10) indicating that the login request has been accepted.

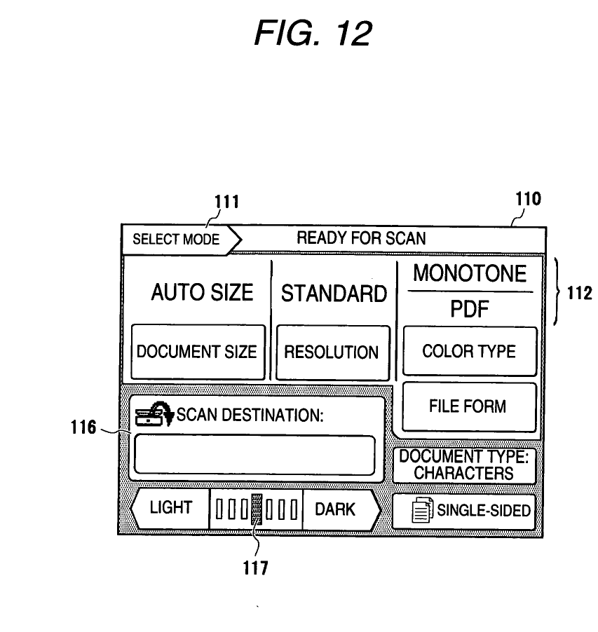

Upon receiving this information, the control unit 11 displays a basic scan screen 110, shown in FIG. 12, on the touch screen 31 (step S104).

A mode select button 111 on the basic scan screen 110 is a button that when touched, and thus selected, instructs the control unit 11 to start the operation in the copy mode.

Setup value areas 112 on the basic scan screen 110 are areas wherein current setup values are shown for document size, resolution, color type and file form. A “document size” button, a “resolution” button, a “color type” button and a “file form” buttons are used to change the setup values for document size, resolution, color type and file form.

A “document type” button is used to designate the type of document (printed matter, a photograph or a document covered mainly with characters), and the current setup value (character in FIG. 12) is shown inside the “document type” button. A “single-side/double-side select” button is used to designate the reading of either a single side or both sides of a document, and the current setup value is also shown inside the “single side/double-side select” button.

When these buttons are touched, and thus selected, corresponding screens are displayed on the touch screen 31.

A “light” button and a “dark” button (buttons for adjusting the scan density), provided on the basic scan screen 110, are buttons that when touched, and thus selected, prevent other screens from being displayed, i.e., a density cursor on the display is moved.

A “scan destination” button 116 is used to designate a storage folder for a scan file or a transmission destination for a scan email.

When the scan destination button 116 is touched, and thus selected, the control unit 11 transmits a scan destination list request to the scan agent computer 50 (step S105 in FIG. 10).

Upon receiving the scan destination list request, the scan agent computer 50 prepares a scan destination list that includes the name of each transmission destination designation information set, which is stored in the computer 50 as information relevant to a current user, and information indicating that the transmission destination designation information is used for saving, for an email or for a group, and transmits the scan destination list to the control unit 11 (step S203). As previously described, since during the user registration the scan agent computer 50 automatically generates transmission destination designation information that is used for saving and that concerns a public folder, and stores this information in the computer 50, the scan destination list transmitted to the digital multifunction apparatus 10 at step S203 includes information concerning the public folder (“Public Folder”, and information that the transmission destination designation information named as the “Public Folder” is used for saving), even if the current user has not yet performed any process for registering the transmission destination designation information.

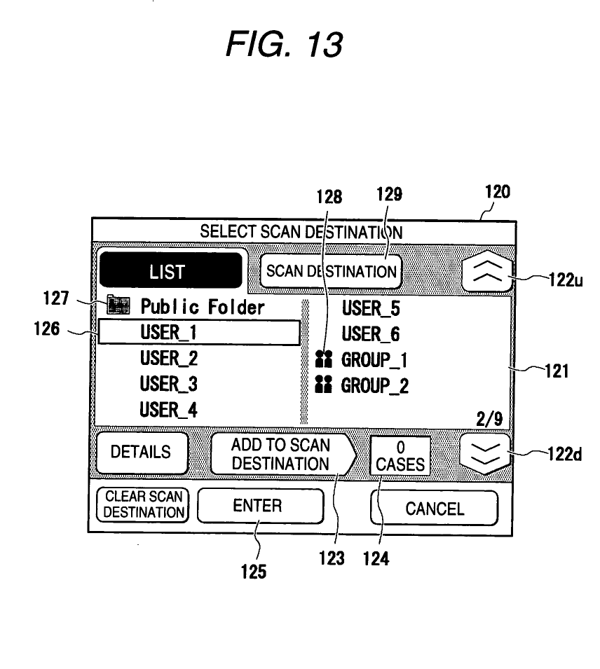

The control unit 11 employs the received scan destination list to display a scan destination selection screen 120, shown in FIG. 13, on the touch screen (step S106).

A list area 121 on the scan destination selection screen 120 is used to display the name (e.g., “Public Folder” or “USER_{—}1”; hereinafter also referred to as a transmission destination designation information name) of each transmission destination designation information set included on the scan destination list. For the transmission destination designation information used for saving, a FIG. 127 and an information name, such as “Public Folder, are displayed in the list area 121; for the transmission destination designation information used for email, only an information name, such as “USER_{—}1, is displayed; and for the transmission destination designation information used for a group, a FIG. 128 and an information name, such as “GROUP_{—}1”, are displayed.

Furthermore, by performing the following operation, an arbitrary number of transmission destination designation information sets can be selected on the scan destination selection screen 120.

When a user desires to select specific transmission destination designation information (transmission destination designation information used for saving, transmission destination designation information used for email, or transmission destination designation information used for a group), he or she touches, and thus selects, a button 122u or a button 122d, so that a selection block 126 appears in the area wherein the desired transmission destination designation information name is displayed. Then, the user selects an “add to scan destination” button 123.

When the user has selected the “add to scan destination” button 123, the control unit 11 registers the selection of the transmission destination designation information corresponding to the transmission destination designation information name enclosed in the selection block 126. Further, the control unit 11 increments, by one, the numerical value displayed in a selection case count block 124, and deletes, from the list area 121, the transmission destination designation information name enclosed in the selection block 126.

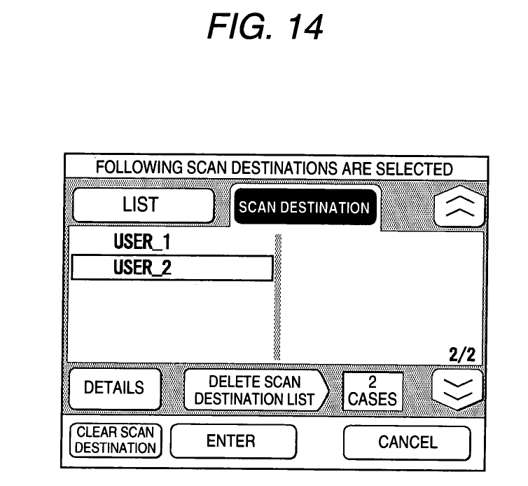

To select a plurality of transmission destination designation information sets, the user must repeat the above described operation for each set, and must touch and select an “enter” button 125. It should be noted that when a scan destination button 129 on the scan destination selection screen 120 is selected, a scan destination confirmation/deletion screen shown in FIG. 14 is displayed on the touch screen. When the user wishes to confirm the selected transmission destination designation information, he or she need only display this scan destination confirmation/deletion screen and select an “enter” button provided thereon (or the “enter” button on the scan destination selection screen 120).

When the user selects the “enter” button 125 (or the “enter” button on the scan destination confirmation/deletion screen), the basic scan screen 110 (see FIG. 2) is displayed wherein information related to the transmission destination designation information selected by the user, i.e., the list of transmission destination designation information names, is displayed in the “scan destination” button 116 (step S107).

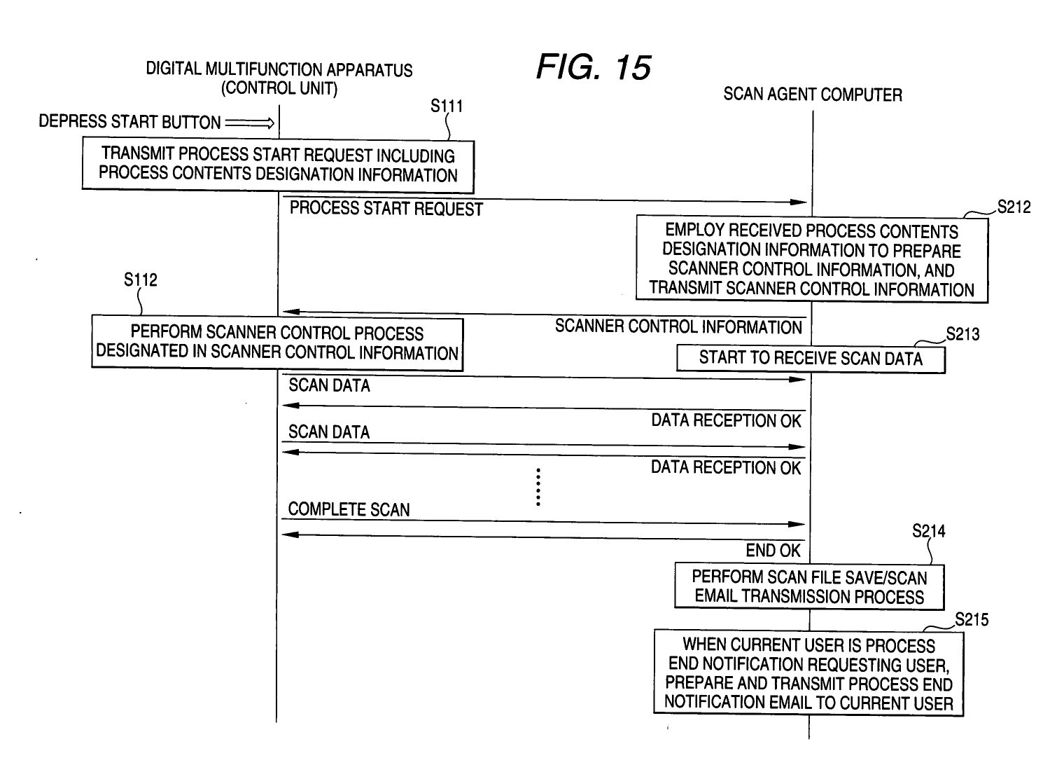

In the scan file generation system for this embodiment, when the start button 32s of the control unit 11 is depressed while a scan destination is designated, i.e., at least one set of transmission destination designation information is selected and the control unit 11 and the scan agent computer 50 perform the scan-to-file process/scan-to-email process shown in FIG. 15.

That is, when the start button 32s is depressed while a scan destination is selected, the control unit 11 transmits, to the scan agent computer 50, a process start request that includes the current process contents designation information (a set of setup values that are displayed on the basic scan screen 110 and that represent the process contents) (step 111).

Upon receiving the process start request, the scan agent computer 50 produces scanner control information based on the process contents designation information included in the request, and transmits the scanner control information to the control unit 11 (step S212). The scanner control information is information (a command) for controlling the scanner 12 and is obtained by converting each set of data (only data related to the control of the scanner 12) included in the process contents designation information.

The control unit 11 performs, for the scanner 12, a control process designated by the scanner control information (step S112). In short, the control unit 11 starts the operation of the scanner 12.

The control unit 11 is then ready for transmitting, to the scan agent computer 50, scan data output by the scanner 12, i.e., image data obtained by the scanner when scanning a document.

On the other hand, after the scan agent computer 50 has transmitted the scanner control information to the control unit 11, the scan agent computer 50 receives scan data from the control unit 11 and starts a process for storing the scan data on an HDD (step S213). Furthermore, when the scan agent computer 50 receives, from the control unit 11, information indicating that the transmission of all the scan data has been completed (scan end in FIG. 12), the scan agent computer 50 performs a scan file save/scan email transmission process (step S214). During the scan file save/scan email transmission process, scan data that have been received are employed to generate a scan file having a form that is designated in the current process contents designation information (process contents designation information received from the digital multifunction apparatus 10 at step S112). Then, for each transmission destination designation information set used for saving that is included in the process contents designation information, a scan file is stored in a folder designated by the transmission destination designation information. As for each transmission destination designation information set used for email and for a group that is included in the process contents designation information, an email to which the generated scan file is attached, i.e., a scan email, is transmitted to an address that is regarded as having been designated by the transmission destination designation information.

When the scan file save/scan email transmission process has been completed, and when a current user is a person to whom a process end notification email should be transmitted (a process end notification requesting user in FIG. 12), the scan agent computer 50 adds, to a case name and text, information representing the contents of the process that has been performed and the process results, and prepares and transmits a process end notification email to the email address of the current user (step S215).

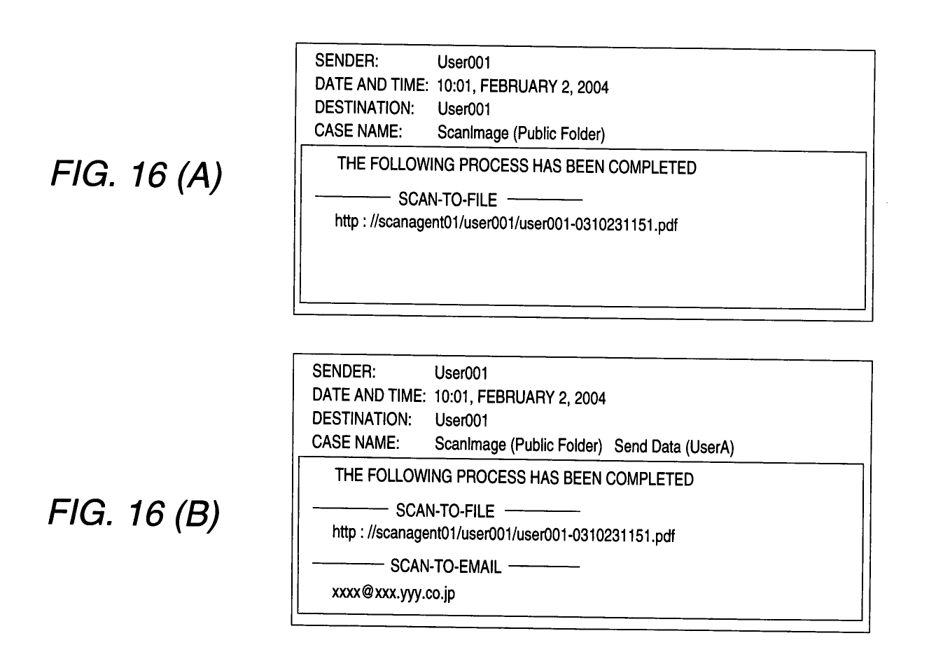

More specifically, at step S215, the scan agent computer 50 prepares and transmits a process end notification email that includes the contents shown in FIGS. 16A and 16B. That is, the scan agent computer 50 transmits, to the current user, a process end notification email that includes: a case name, which is a character string consisting of the transmission destination designation information names (“Public Folder” and “UserA”) included in the current process contents designation information, and information (“ScanImage” and “SendData”) indicating the types of processes performed for the individual sets of transmission destination designation information names; and text comprising the URL (or UNC information for scan files stored in other than the public folder) and the destination address for a scan email transmitted during the scan-to-email process.

An explanation will now be given for the operation performed by the scan agent computer 50 when a user employs a Web browser to access it.

When a user desires to browse, download or delete a scan file stored in the public folder, or to register an email address (to display the destination setup page 65 on the computer 210), the user activates the Web browser on his or her computer 210 and enters, using the Web browser, a predetermined URL (the same as that entered by the manager during the login) that includes the IP address of the scan agent computer 50.

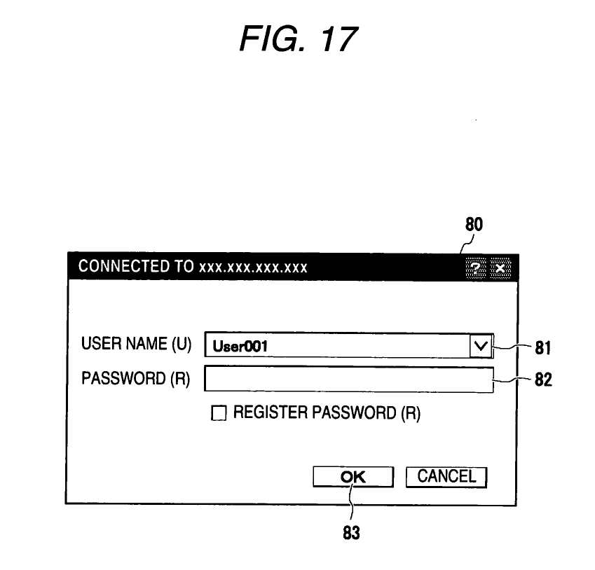

When this operation has been performed, the computer 210 (Web browser) and the scan agent computer 50 can communicate with each other, and as a result, as is shown in FIG. 17, a login screen 80, on which a dropdown list box 81, for enabling the selection of a user name, a text box 82, for enabling the entry of a password, and an OK button 83 are provided, is displayed on the computer 210.

A user who has registered his or her password enters his or her user name in the dropdown box 81 on the login screen 80, enters his or her password in the text box 82, and clicks the OK button 83. A user who has not yet registered his or her password enters his or her user name in the dropdown list box 81 and clicks the OK button 83, without entering anything in the text box 82.

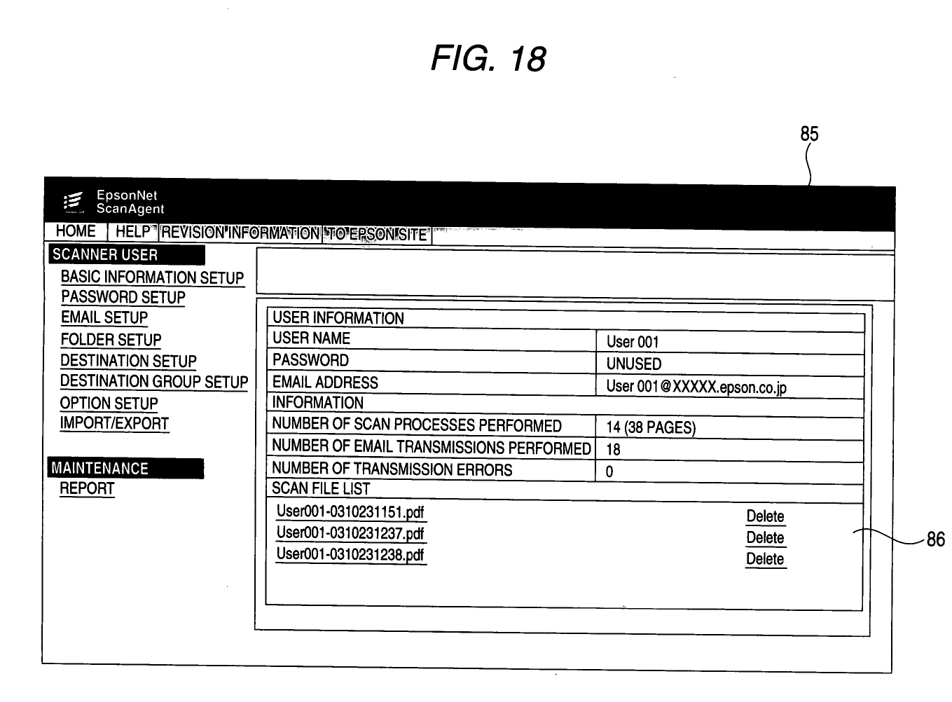

When the OK button 82 is clicked, the computer 210 (Web browser) transmits to the scan agent computer 50 the user name and the password entered by the user (or information to the effect that the user did not enter a password). The scan agent computer 50 confirms that user management information consonant with the received information is stored in the computer 50, and obtains the file name of each scan file that is stored in the public folder and is related to the current user (the user identified by the user name that is displayed in the dropdown box 81 when the OK button 83 is clicked), and employs the obtained file name to display, on the computer 210, a user homepage 85, shown in FIG. 18. In other words, the scan agent computer 50 prepares HTML data for the user homepage 85 and transmits the HTML data to the computer 210.

That is, the scan agent computer 50 permits the computer 210 to display the user homepage 85 that provides a scan file list area 86 that includes links, such as “User001-0310231.pdf’, to the individual scan files that are currently stored in the public folder of the current user, and items, such as “Delete”: link to a CGI program, for deleting the individual scan files.

As is described above, according to the scan file generation system of this embodiment, when the user employs the Web browser to log in at the scan agent computer 50, the user home page 85 is displayed whereon links are provided to the individual scan files stored in the public folder of the user. Therefore, compared with a conventional system wherein the OS function must be employed to use a scan file, the scan file generation system of this embodiment permits the user to easily perform an operation for which a scan file is used.

Furthermore, the scan file generation system in this embodiment has a function for transmitting a process end notification email for which the URL of a scan file stored in the public folder is designated as an address (a function that also permits an email sender to employ a scan file). Because of this function, this scan file generation system permits a user to more easily perform an operation using a scan file than does the conventional system.

<Modification>

The scan file generation system for this embodiment can be variously modified. For example, while the scan file generation system performs the scan-to-file process and the scan-to-email process, the scan file generation system may be modified so as to perform only the scan-to-file process. Further, the scan file generation system may be modified so as to disable the selection of a folder, i.e., to store a scan file only in a public folder. Furthermore, the scan file generation system may be modified so that the digital multifunction apparatus 10 (control unit 11) can register a user name.

1. A scan file generation system, which is connected to a computer network constituted by several computers in which web browsers are installed, comprising:
a scan data generation apparatus; and
a scan file generation apparatus,
wherein the scan data generation apparatus includes
a document scanner for scanning a document that has been set thereon, and generating image data representing an image of the document,
a user interface unit for permitting a user to perform various operations, including an input operation for a user name allocated to the user, and
a controller which, when predetermined operations, including the input operation for the user name, are performed using the interface unit, transmits user name information indicative of the user name entered during the input operation, to the scan file generation apparatus, starts operation of the document scanner and transmits image data, produced by the document scanner, to the scan file generation apparatus, and
wherein the scan file generation apparatus includes
a scan file generation/storage unit for receiving the user name information and the image data from the controller of the scan data generation apparatus, for generating a scan file that is related to the image data, and for storing the scan file in correlation with the user name indicated by the user name information, and
a scan file provision unit which, when operations including an input operation for the user name are performed using the web browser installed in one of the computers, outputs data to the one computer to display on the one computer a scan file selection page, that is a web page and that permits the user to arbitrarily select one or ones of the scan files stored in the scan file generation/storage unit in correlation with the user name, and which, when selection of the one or ones of the scan files is performed using the displayed scan file selection page on the one computer, provides the selected one or ones of the scan files from the scan file generation/storage unit to the one computer.

2. A scan file generation system according to claim 1, wherein:
the user interface unit of the scan data generation apparatus has a function of enabling a designation operation for designating a folder;
the controller of the scan data generation apparatus has a function of transmitting, to the scan file generation apparatus, folder information indicating the folder designated by the designation operation performed using the user interface unit; and wherein the scan file generation apparatus further includes
the scan file generation/storage unit of the scan file generation apparatus is operated if the folder information received from the controller represents a predetermined content; and
the scan file generation apparatus further includes a second scan file generation/storage unit which is operated if the folder information received from the controller represents a content other than the predetermined content and which receives the user name information and the image data from the controller of the scan data generation apparatus, generates a scan file that is related to the image data, and stores the scan file in the folder designated in the folder information.

3. A scan file generation system according to claim 1, wherein the scan file generation apparatus further includes:
the scan file generation/storage unit having a function of storing scan files having forms identifiable by using URLs;
an email address storage unit for storing email addresses in consonance with a plurality of the user names; and
a process end notification email transmission unit for, when a new scan file is stored in the scan file generation/storage unit, setting a URL for the new scan file in text and transmitting a process end notification email to an email address that is stored, as a destination address, in the email address storage unit in correlation with the user name.

4. A scan file generation system according to claim 1, wherein the scan file generation apparatus further includes:
an effective period information storage unit for storing, for each of a plurality of the user names, effective period information representing a period of time; and
a scan file deletion unit for managing elapsed time following the storage of a scan file in the scan file generation/storage unit, and for deleting the scan file when the elapsed time exceeds the period of time represented by the effective period information stored, in correlation with a corresponding user name, in the effective period information storage unit.
